(19) United States
(12) Patent Application Publication
(10) Pub. No.: US 2014/0243477 A1
(43) Pub. Date: Aug. 28, 2014

(54) ADDITIVES FOR STABILIZING POLYMERS WITH RESPECT TO HYDROLYSIS

(71) Applicant: BASF SE, Ludwigshafen (DE)

(72) Inventors: Laurence POTTIE, Koeln (DE); Theo SMIT, Heidelberg (DE); Arno LANGE, Bad Duerkheim (DE); Collin G. MOORE, Chesterland, OH (US); Simone SCHILLO, Ludwigshafen (DE); Volker FRENZ, Altleiningen (DE); Roelof VAN DER MEER, Halsteren (NL)

(73) Assignee: BASF SE, Ludwigshafen (DE)

(21) Appl. No.: 14/190,660

(22) Filed: Feb. 26, 2014

Related U.S. Application Data
(60) Provisional application No. 61/769,777, filed on Feb. 27, 2013.

(51) Int. Cl. C08F 230/08; C08F 220/18; C08L 67/02

(52) U.S. Cl. CPC C08F 230/08; C08L 67/02; C08F 220/18
USPC 525/175; 526/273

(57) ABSTRACT

Use of copolymers (C) comprising at least one epoxy group and at least one alkoxysilane group as stabilizers for polymers (P), where the copolymers (C) are generally obtained via polymerization of monomers and said monomers comprise those that comprise epoxy groups or alkoxysilane groups or epoxy groups and alkoxysilane groups, or that are reacted during or after polymerization and, after the reaction, comprise epoxy groups or alkoxysilane groups, or epoxy groups and alkoxysilane groups. Processes for stabilizing polymers (P) with respect to hydrolysis, which comprise adding, to the polymers (P), an effective amount of copolymers (C). Copolymers (C′) composed of specific compositions of monomers comprising at least one epoxy group and at least one alkoxysilane group, and also optionally other monomers. Mixtures comprising copolymers (C′) and polymers (P).

The present invention relates to the use of copolymers (C) comprising at least one epoxy group and at least one alkoxysilane group as stabilizers for polymers (P). The invention further relates to processes for stabilizing polymers with respect to hydrolysis via addition of copolymers (C). The invention further relates to selected copolymers (C′) and mixtures comprising copolymers (C′).

Other embodiments of the present invention can be found in the claims, the description, and the examples. The abovementioned features of the subject matter of the invention, and the features thereof which will be explained hereinafter, can of course be used not only in the specific combination stated but also in other combinations, without exceeding the scope of the invention. Preferred and very preferred embodiments of the present invention in particular include those in which all of the features of the subject matter of the invention have the preferred and, respectively, very preferred meanings.

Polymers having hydrocarbon chains and alkoxysilane groups can crosslink and are therefore frequently used as starting materials for adhesive masses or for sealants, or for compositions for surface modification.

There are various known production processes for polymers having hydrocarbon chains and siloxane groups: U.S. Pat. No. 6,177,519 B1 describes the grafting of a polyolefin with a vinylsiloxane; U.S. Pat. No. 6,194,597 B1 moreover discloses the copolymerization of isobutene with silylstyrene or silylmethylstyrene.

WO 2012/032005 A1 describes terpolymers obtainable via copolymerization of electron-deficient olefins, of olefins which, at their olefinic double bond, bear only hydrogen atoms and/or carbon atoms, without electron-withdrawing substituents, and of alkoxyvinylsilanes, and also describes downstream products obtainable via modification or crosslinking of these terpolymers.

U.S. Pat. No. 5,354,802 describes resin compositions for blow molding comprising from 0.2 to 10 parts by weight of a styrene copolymer comprising from 40 to 97% by weight of styrene, from 60 to 3% by weight of a glycidyl ester of an alpha, beta-unsaturated acid, and from 0 to 50% by weight of other vinylic monomers.

U.S. Pat. No. 6,984,694 B2 describes the use of copolymers comprising epoxy-functionalized (meth)acrylic acid monomers, styrene and/or (meth)acrylic acid monomers, as chain extenders.

U.S. Pat. No. 4,393,156 and U.S. Pat. No. 4,393,158 describe the use of epoxysilanes and of certain epoxysiloxanes for stabilizing polyester carbonates or aromatic polycarbonates with respect to hydrolysis. However, the epoxysiloxanes described in that document do not involve copolymers comprising epoxy groups and alkoxysilane groups.

The unpublished PCT/EP2012/072489 describes mixtures comprising polyfunctional chain extenders and mono- or difunctional hydrolysis stabilizers for polymers.

Carbodiimides are often used industrially to stabilize polymers with respect to hydrolysis, an example being Stabaxol I, from Rhein Chemie. Monomeric carbodiimides are also known by way of example from U.S. Pat. No. 5,439,952 as hydrolysis stabilizers. However, their use often produces toxic byproducts, for example phenyl isocyanates.

Polymers, for example polycondensation polymers such as polyesters, are often susceptible to hydrolytic degradation at elevated temperatures. Conditions of this type occur by way of example when the polymers are processed with introduction of heat while moisture is simultaneously present. Hydrolysis of the polymers leads to molecular-weight reduction and to reduced melt viscosity, with simultaneous impairment of the mechanical properties of the polymers. These effects greatly restrict the usefulness of these hydrolysable polymers, and moreover result in high costs for drying before the polymers are processed.

It was therefore an object of the present invention to provide stabilizers which can be used for polymers and which reduce degradation and reduce the extent of hydrolysis. A particular object of the invention was to suppress reduction of the melt viscosity of polymers during processing. Another object of the present invention was to provide hydrolysis stabilizers which do not exhibit toxic byproducts.

Said objects have been achieved via the use of copolymers (C) comprising at least one epoxy group and at least one alkoxysilane group, as stabilizers for polymers (P), preferably comprising at least two epoxy groups and two alkoxysilane groups. It is preferable that the copolymers (C) are used as hydrolysis stabilizers or acid scavengers.

For the process of the present invention, alkoxysilane groups are groups of the general formula (I):

*—Si(OR¹)ₙ(R²)₃₋ₙ (I)

where
n is 1, 2, or 3, preferably 3,
R¹ and R², being identical or different, are mutually independently H, C₁-C₂₀-alkyl, C₂-C₂₀-alkenyl, C₂-C₂₀-alkynyl, C₃-C₁₅-cycloalkyl, preferably H, C₁-C₂₀-alkyl.

For the purposes of the present invention, epoxy groups are groups of the general formula (II):

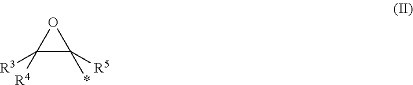

where
R³, R⁴, and R⁵, being identical or different, are mutually independently H, C₁-C₂₀-alkyl, C₂-C₂₀-alkenyl, C₂-C₂₀-alkynyl, C₃-C₁₅-cycloalkyl, preferably H, C₁-C₄-alkyl.

For the purposes of this invention, expressions of the type Cₐ-C_{b} indicate chemical compounds or substituents with a certain number of carbon atoms. The number of carbon atoms can be selected from the entire range from a to b, inclusive of a and b, a is at least 1, and b is always greater than a. Expressions of the type Cₐ-C_{b}-V are used for further specification of the chemical compounds or of the substituents. V here represents a class of chemical compound or class of chemical substituent, for example alkyl compounds or alkyl substituents.

The collective expressions used for the various substituents have the following detailed meanings:

C₁-C₂₀-alkyl: straight-chain or branched hydrocarbon moieties having up to 20 carbon atoms, for example C₁-C₁₀-alkyl or C₁₁-C₂₀-alkyl, preferably C₁-C₁₀-alkyl, for example C₁-C₃-alkyl, such as methyl, ethyl, propyl, isopropyl, or C₄-C₆-alkyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl, 1-ethyl-2-methylpropyl, or C₇-C₁₀-alkyl, such as heptyl, octyl, 2-ethylhexyl, 2,4,4-trimethylpentyl, 1,1,3,3-tetramethylbutyl, nonyl or decyl, or else isomers of these.

C₂-C₂₀-alkenyl: unsaturated, straight-chain or branched hydrocarbon moieties having from 2 to 20 carbon atoms and having a double bond in any desired position, for example C₂-C₁₀-alkenyl or C₁₁-C₂₀-alkenyl, preferably C₂-C₁₀-alkenyl, e.g. as C₂-C₄-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, or C₅-C₆-alkenyl, such as 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-l-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1 -pentenyl, 2-methyl-1 -pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl or 1-ethyl-2-methyl-2-propenyl, or else C₇-C₁₀-alkenyl, such as the isomers of heptenyl, octenyl, nonenyl or decenyl.

C₂-C₂₀-alkynyl: straight-chain or branched hydrocarbon groups having from 2 to 20 carbon atoms and having a triple bond in any desired position, for example C₂-C₁₀-alkynyl or C₁₁-C₂₀-alkynyl, preferably C₂-C₁₀-alkynyl, e.g. C₂-C₄-alkynyl, such as ethynyl, 1-propynyl, 2-propynyl, 1-butynyl, 2-butynyl, 3-butynyl, 1-methyl-2-propynyl, or C5-C7-alkynyl, such as 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1 -butynyl, 1-ethyl-2-butynyl, 1-ethyl-3-butynyl, 2-ethyl-3-butynyl, or 1-ethyl-1-methyl-2-propynyl, or else C7-C10-alkynyl, such as the isomers of heptynyl, octynyl, nonynyl, decynyl.

C₃-C₁₅-cycloalkyl: monocyclic, saturated hydrocarbon groups having from 3 to 15 carbon ring members, preferably C₃-C₈-cycloalkyl such as cyclopropyl, cyclobutyl, cyclopentyl, cyclohexyl, cycloheptyl or cyclooctyl, or else a saturated or unsaturated cyclic system, e.g. norbornyl or norbenyl.

Aryl: a mono- to trinuclear aromatic ring system comprising from 6 to 14 carbon ring members, e.g. phenyl, naphthyl, or anthracenyl, preferably a mono- to binuclear aromatic ring system, particularly preferably a mononuclear aromatic ring system.

For the purposes of the present invention, the symbol “*” in all chemical compounds characterizes the valency by way of which a chemical group has linkage to another chemical group.

In one preferred embodiment of the claimed use, the copolymers (C) are obtained via polymerization of monomers, where said monomers comprise those which
(a) comprise epoxy groups or alkoxysilane groups or epoxy groups and alkoxysilane groups or
(b) are subjected to reaction during or after polymerization, and after the reaction comprise epoxy groups or alkoxysilane groups or epoxy groups and alkoxysilane groups.

These monomers preferably correspond to the general formulae (III) and (IV):

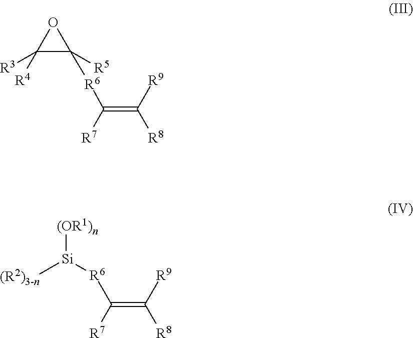

where
n is 1, 2, 3, preferably 3,
R¹ and R², being identical or different, are mutually independently H, C₁-C₂₀-alkyl, C₂-C₂₀-alkenyl, C₂-C₂₀-alkynyl, C₃-C₁₅-cycloalkyl, preferably H, C₁-C₂₀-alkyl,
R³, R⁴, and R⁵, being identical or different, are mutually independently H, C₁-C₂₀-alkyl, C₂-C₂₀-alkenyl, C₂-C₂₀-alkynyl, C₃-C₁₅-cycloalkyl, preferably H, C₁-C₄-alkyl,
R⁷, R⁸, and R⁹, being identical or different, are mutually independently H, C₁-C₂₀-alkyl, C₂-C₂₀-alkenyl, C₂-C₂₀-alkynyl, C₃-C₁₅-cycloalkyl, preferably H, C₁-C₂₀-alkyl, very preferably H or C₁-C₄-alkyl,
R⁶ is a single bond, C₁-C₂₀-alkylene, or —C(O)O—R¹⁰—,
R¹⁰ is a single bond or C₁-C₂₀-alkylene.

It is preferable that at least 10%, particularly at least 20%, very particularly at least 30%, in particular at least 40%, of the monomers of the copolymers (C) comprise epoxy groups.

It is further preferable that at least 10%, particularly at least 20%, very particularly at least 30%, in particular at least 40%, of the monomers of the copolymers (C) comprise alkoxysilane groups.

In one preferred embodiment of the claimed use, the monomers of the copolymers (C) are selected from glycidyl acrylate, glycidyl methacrylate, styrene, vinyltriethoxysilanes, methacryloxypropyltrimethoxysilane, methacryloxypropyltris(2-propoxy)silane, methyl methacrylate, butyl acrylate, 2-ethylhexyl acrylate, 2-propylhexyl acrylates, and alpha-methylstyrene. Preference is given to glycidyl methacrylate, vinyltriethoxysilane, methacryloxypropyltrimethoxysilane, styrene, and methyl methacrylate.

In another preferred embodiment of the claimed use, precisely two, three, or four monomers are selected of which the copolymers (C) are composed. In this case, there are no other monomers then present in the copolymer (C).

It is preferable that the precisely two monomers involve glycidyl methacrylate and vinyltriethoxysilane. In particular here, glycidyl methacrylate and vinyltriethoxysilane are used in a molar ratio in the range from 10:90 to 90:10, preferably from 20:80 to 80:20, particularly preferably from 30:70 to 70:30, very particularly preferably from 40:60 to 60:40.

It is further preferable that the precisely two monomers involve glycidyl methacrylate and methacryloxypropyltrimethoxysilane. In particular here, glycidyl methacrylate and methacryloxypropyltrimethoxysilane are used in a molar ratio in the range from 10:90 to 90:10, preferably from 20:80 to 80:20, particularly preferably from 30:70 to 70:30, very particularly preferably from 40:60 to 60:40.

It is further preferable that the precisely four monomers involve glycidyl acrylate, styrene, methyl methacrylate and methacryloxypropyltrimethoxysilane. In particular here, glycidyl acrylate and methacryloxypropyltrimethoxysilanes are used in a molar ratio in the range from 0.01 to 10.

The weight-average molar mass Mw of the copolymers (C) is preferably in the range from 100 to 50 000 g/mol, preferably from 2400 to 20 000, particularly preferably from 3500 to 13 000.

The copolymers (C) are produced by processes known to the person skilled in the art from the prior art, for example those described in WO 2012/098063 A1 or WO 2012/044981 A2.

In one preferred embodiment of the claimed use, the polymers (P) are polycondensates or polyadducts. It is preferable that the polymers (P) here are selected from the group of the polyesters, polyamides, polyurethanes, polycarbonates, and copolymers of these. In particular, the polymers (P) are selected from polyethylene terephthalates (PET), polybutylene terephthalates (PBT), polyethylene naphthalate (PEN), polycarbonate (PC), acrylonitrile-butadiene-styrene copolymer (ABS), biodegradable aliphatic-aromatic copolyesters, biopolymers, and nylon-6 (PA6).

The invention also provides a process for stabilizing polymers (P) with respect to hydrolysis, which comprises adding, to the polymers (P), an effective amount of copolymers (C). It is preferable that the amount of the copolymers (C) added is from 0.01 to 10% by weight, based on the total amount of polymer (P) and copolymer (C).

The addition of the copolymers (C) to the polymers (P) is achieved via processes known to the person skilled in the art from the prior art. In particular, the addition is achieved via extrusion or compounding.

The invention also provides copolymers (C′) composed of
(a) from 4.99 to 90 mol %, preferably from 5 to 58 mol %, particularly preferably from 10 to 50 mol %, of a monomer comprising at least one epoxy group,
(b) from 0.01 to 90 mol %, preferably from 2 to 50 mol %, particularly preferably from 15 to 35 mol %, of a monomer comprising at least one alkoxysilane group,
(c) from 0 to 95 mol %, preferably from 40 to 93 mol %, particularly preferably from 55 to 75 mol %, of at least one monomer differing from (a) and (b),
   where the total proportion of monomers (a), (b), and (c) is 100 mol %.

It is preferable that copolymers (C′) are composed of
(a) from 10 to 90 mol % of glycidyl methacrylate,
(b) from 10 to 90 mol % of vinyltriethoxysilane,
(c) from 0 to 50 mol % of at least one monomer differing from (a) and (b),
   where the total proportion of monomers (a), (b), and (c) is 100 mol %.

It is further preferable that copolymers (C′) are composed of
(a) from 4.99 to 70 mol %, preferably from 10 to 50 mol %, of glycidyl acrylate,
(b) from 0.01 to 60 mol %, preferably from 5 to 50 mol %, of methacryloxypropyltrimethoxysilane,
(c) from 0 to 95 mol %, preferably from 0 to 50, of styrene and/or methyl methacrylate.

The copolymers (C′) are produced by the processes described above for the copolymers (C).

The invention also provides mixtures comprising copolymers (C′) and polymers (P), where the polymers (P) are preferably polycondensates or polyadducts. It is preferable that the amount of the copolymers (C) comprised in the mixtures is from 0.01 to 10% by weight.

It is further preferable that the polymers (P) here are selected from the group of the polyesters, polyamides, polyurethanes, polycarbonates, and copolymers of these.

It is likewise preferable that the polymers (P) here are PET, PBT, PEN, PC, ABS, biodegradable aliphatic-aromatic copolyesters, biopolymers, or PA6.

The mixtures are produced via processes known to the person skilled in the art from the prior art. In particular, the addition is achieved via extrusion or compounding.

The present invention provides copolymers (C) for stabilizing polymers, where these bring about a reduction of the melt viscosity of polymers and by virtue of their polymeric structure are less toxic during handling, incorporation, and use as stabilizer. The copolymers (C) used for the purposes of the present invention exhibit excellent properties in particular as hydrolysis stabilizers for polyaddition polymers and polycondensation polymers.

The examples provide further explanation of the invention, but do not restrict the subject matter of the invention.

### EXAMPLES

### Example 1

A copolymer of vinyltriethoxysilane (VTEOS) and glycidyl methacrylate (GMA) was produced in accordance with the processes of WO 2012/098063 A1 with the aid of free-radical polymerization. The production process took place in (26% by weight, based on the entire reaction solution) toluene as solvent at a temperature of 120° C. The molar ratio of VTEOS to GMA was about 1:1 (152.8 g of VTEOS and 113.8 g of GMA). Tert-butyl peroxybenzoate (2.6 mol %, based on the amount of monomers) was added as free-radical initiator. The reaction time was 6 hours. A cloudy, viscous polymer solution was obtained.

Diagram of the linear copolymer of example 1:

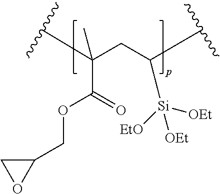

### Example 2

A copolymer of glycidyl methacrylate (GMA), methyl methacrylate (MMA), styrene (ST), and methacryloxypropyltrimethoxysilane (TMSMA) was produced in accordance with the processes of WO 2012/044981 A2 with the aid of high-temperature polymerization. The production process was in accordance with example 15 of WO 2012/044981 A2. Table 1 describes the molar ratio of the monomers.

Diagram of the copolymer of example 2:

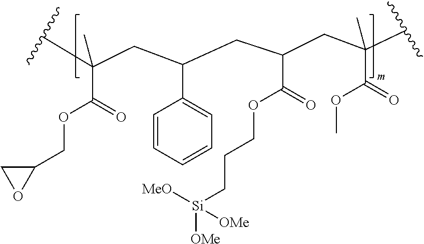

TABLE 1

| | | Mol % of | Mol % of | Mol % | Mol % of |
|---|---|---|---|---|---|
| | Molar mass, | GMA in | TMSMA in | of ST | MMA in |
| Example | Mn (g/mol) | feed | feed | in feed | feed |
| 2a | 2400 | 27.96 | 5.24 | 65.6 | 1.2 |
| 2b | 2500 | 18.99 | 5.1 | 74.74 | 1.17 |
| 2c | 2800 | 10.42 | 4.95 | 83.48 | 1.15 |

Data in mol % are based on the total molar amount of monomers.

### Example 3

Polyethylene terephthalate (PET) for producing biaxially oriented foils was purchased from Mitsubishi Polyester Film GmbH, Wiesbaden. The PET had a low concentration of carboxylic end groups (about 21 mmol/kg). The acid numbers were obtained via titration of the respective PET solution in a solvent mixture of chloroform/cresol.

The stabilizers (copolymers (C)) were extruded in various concentrations together with the PET at a temperature of 260° C.

The resultant foils were then exposed to elevated temperatures (110° C.) and high humidity (100%) and stored for a period of two and, respectively, five days (2d, 5d).

The degradation of the polymer was determined via measurement of intrinsic viscosity (IV) and/or of acid end group concentration of the PET prior to and after storage. The IV measurements (units in mg/I) were carried out with the aid of a micro-Ubbelohde capillary viscometer, using a 1:1 mixture of phenol and o-dichlorobenzene as solvent.

Unless otherwise stated, the polymers extruded without stabilizers were in each case used as reference (REF 1, REF 2, and REF IND).

In a comparative experiment (IND REF), Stabaxol I (Rhein Chemie), which is frequently used in industry, was likewise incorporated in PET.

TABLE 2

| | | Amount of | Concentration | | | | | |
|---|---|---|---|---|---|---|---|---|
| | | stabilizer | of acid groups | | | | | |
| | | added (% | (mg/kg) | | | IV (mg/l) | | |
| Example | Stabilizer | by wt.) | 0 d | 2 d | 5 d | 0 d | 2 d | 5 d |
| REF 1 | — | 0 | 21 | 34 | | — | 70 | |
| 3a | Example 1 | 0.2 | 20 | 33 | | 75 | 58 | |
| 3b | Example 1 | 0.6 | 14 | 26 | | 73 | 59 | |
| REF 2 | — | 0 | 29 | 67 | 129 | 64 | 42 | 31 |
| 3c | Example 2a | 0.6 | 28 | 50 | 99 | 68 | 52 | 38 |
| 3d | Example 2a | 1 | 21 | 36 | 84 | 77 | 62 | 46 |
| 3e | Example 2b | 0.6 | 32 | 58 | 118 | 66 | 72 | 70 |
| 3f | Example 2b | 1 | 30 | 61 | 113 | 72 | 49 | 35 |
| 3g | Example 2c | 0.6 | 32 | 61 | 116 | 64 | 49 | 34 |
| 3h | Example 2c | 1 | 32 | 53 | 105 | 66 | 50 | 35 |
| REF IND | — | 0 | 22 | 48 | 100 | 67 | 51 | 37 |
| IND REF 1 | Stabaxol I | 0.6 | 9 | 18 | 59 | 68 | 62 | 46 |
| IND REF 2 | Stabaxol I | 1 | 3 | 5 | 19 | 69 | 68 | 62 |

Data in % by wt. are based on the total amount of stabilizer and PET.

As can be seen from table 2, the copolymers (C) stabilize the PET with respect to hydrolytic degradation. Although resultant concentrations of acid groups are higher, when comparison is made with the Stabaxol results, good stabilization of viscosity properties is surprisingly nevertheless obtained.

1. A process for stabilizing a polymer (P), comprising adding an effective amount of a copolymer (C) comprising an epoxy group and an alkoxysilane group as a stabilizer, to the polymer.

2. The process according to claim 1, wherein the copolymer (C) is obtained via polymerization of monomers and the monomers either:
(a) comprise epoxy groups or alkoxysilane groups or epoxy groups and alkoxysilane groups; or
(b) are subjected to reaction during or after polymerization, and after the reaction comprise epoxy groups or alkoxysilane groups or epoxy groups and alkoxysilane groups.

3. The process according to claim 1, wherein at least 10% of the monomers of the copolymers comprise epoxy groups.

4. The process according to claim 1, wherein at least 10% of the monomers of the copolymers comprise alkoxysilane groups.

5. The process according to claim 1, wherein the monomers are at least one selected from the group consisting of glycidyl acrylate, glycidyl methacrylate, styrene, vinyltriethoxysilanes, methacryloxypropyltrimethoxysilane, methacryloxypropyltris(2-propoxy)silane, methyl methacrylate, butyl acrylate, 2-ethylhexyl acrylate, 2-propylhexyl acrylates, and alpha-methylstyrene.

6. The process according to claim 1, wherein precisely two, three, or four monomers are selected.

7. The process according to claim 6, wherein precisely two monomers are selected, which are glycidyl methacrylate and vinyltriethoxysilane.

8. The process according to claim 6, wherein precisely two monomers are selected, which are glycidyl methacrylate and methacryloxypropyltrimethoxysilane.

9. The process according to claim 6, wherein precisely four monomers are selected, which are glycidyl acrylate, styrene, methyl methacrylate, and methacryloxypropyltrimethoxysilane.

10. The process according to claim 1, wherein the polymer (P) is a polycondensate or polyadduct.

11. (canceled)

12. A copolymer (C′), comprising:
(a) from 4.99 to 90 mol % of a monomer comprising an epoxy group;
(b) from 0.01 to 90 mol % of a monomer comprising an alkoxysilane group, and
(c) from 0 to 95 mol % of at lest one a monomer differing from (a) and (b), wherein a total proportion of monomers (a), (b), and (c) is 100 mol %.

13. The copolymer (C′) according to claim 12, comprising:
(a) from 10 to 90 mol % of glycidyl methacrylate;
(b) from 10 to 90 mol % of vinyltriethoxysilane; and
(c) from 0 to 50 mol % of at least one monomer differing from (a) and (b).

14. The copolymer (C′) according to claim 12, comprising:
(a) from 4.99 to 70 mol % of glycidyl acrylate,
(b) from 0.01 to 60 mol % of methacryloxypropyltrimethoxysilane; and
(c) from 0 to 95 mol % of styrene and/or methyl methacrylate.

15. A mixture comprising the copolymer (C′) according to claim 12 and a polymer (P).
